(19) United States
(12) Patent Application Publication
(10) Pub. No.: US 2025/0115827 A1
(43) Pub. Date: Apr. 10, 2025

(54) WIPE COMPOSITIONS FOR HAND POLISHING WITH IMPROVED SHINE ON FLATWARE AND OTHER SURFACES

(71) Applicant: ECOLAB USA INC., Saint Paul, MN (US)

(72) Inventors: Erik C. Olson, Eagan, MN (US); Derrick Anderson, Vadnais Heights, MN (US); Wendy Lo, Woodbury, MN (US)

(21) Appl. No.: 18/910,242

(22) Filed: Oct. 9, 2024

Related U.S. Application Data
(60) Provisional application No. 63/588,778, filed on Oct. 9, 2023.

(51) Int. Cl. C11D 1/12; C11D 1/04; C11D 1/37; C11D 3/20; C11D 3/48

(52) U.S. Cl. CPC C11D 1/12; C11D 1/04; C11D 1/37; C11D 3/2082; C11D 3/2093; C11D 3/48; C11D 2111/14

(57) ABSTRACT

Wipe compositions include an anionic surfactant and at least one acid provide cleaning and/or sanitizing without requiring use of personal protective equipment (PPE), are surface compatible to provide surface polishing, and do not result in streaky, hazy or tacky residues on treated surfaces. Liquid and solid compositions are provided. The compositions provide effective alternatives to quaternary ammonium containing compounds. Methods of using the wipe compositions are also provided.

### CROSS REFERENCE TO RELATED APPLICATIONS

This application claims priority under 35 U.S.C. § 119 to provisional patent application U.S. Ser. No. 63/588,778, filed Oct. 9, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to wipe compositions, including sanitizing wipe compositions for polishing various surfaces. The wipe compositions include an anionic surfactant and at least one acid to provide cleaning and/or sanitizing without requiring use of personal protective equipment (PPE), are surface compatible to provide surface polishing, and do not result in streaky, hazy or tacky residues on treated surfaces. The compositions provide effective alternatives to quaternary ammonium containing compounds. Methods of using the wipe compositions are also provided.

### BACKGROUND

Microbial and viral pathogens are an increasing public health concern. Pathogenic viruses present a significant health concern as they are able to persist on surfaces for long periods of time and require complete and reliable inactivation in order to stop disease transmission. Quaternary ammonium compounds have become a commonplace antimicrobial and are widely used within the foodservice industry for food contact sanitizing and disinfectant applications with disinfection claim sets requiring a follow-up rinse step. However, recent regulatory scrutiny over quaternary ammonium compounds may change the utilization of these sanitizing and disinfectant compositions. Accordingly various sanitizing and even virucidal compositions are available, such as disclosed in U.S. Publication No. 2021/0176986.

Products having a no-rinse capability are desirable, although they present challenges due to regulatory requirements for all active and inert ingredients to have a list tolerance designated for chemical substances used as ingredients in antimicrobial pesticide formulations applied to food-contact surfaces in public eating places, dairy-processing equipment, and food-processing equipment and utensils. Various commercially-available products exist in the marketplace that provide no-rinse options for providing antimicrobial and/or virucidal compositions, including against Norovirus, including for example, Purell Professional Food Service Sanitizer as disclosed in U.S. Pat. No. 8,143,309 and Pure Bioscience Pure Hard Surface as disclosed in U.S. Pat. Nos. 6,197,814 and 6,583,176. A further commercial example is Sarafan Speed, an EU product that is an alcohol-based no-rinse viricidal product. However, there are various challenges presented by these products. For example, various products present flammability concerns, impart hazy and/or tacky residues and/or poor surface appearance, having limited compatibility with soft metal surfaces (including aluminum) and are only available as ready-to-use (RTU) formulations instead of concentrates and/or solids, which limits applications of their use. As a result, there are various limitations which set in place a need for improved compositions.

Accordingly, it is an objective to provide compositions and methods for polishing various surfaces, including for example flatware, glassware and other food contact surfaces, to provide clean surfaces without hazy, streaks, deposits, residues and/or stains on the treated surfaces.

It is a further objective of the compositions to provide a product that can offer no-rinse sanitizing. In such embodiments a rinse step can be excluded from the methods. Similarly, in such embodiments a saturated wipe can be further implemented the methods. It is a further objective of the compositions and methods to provide a product that provides disinfection without the use of quaternary ammonium compounds.

A further object of the compositions and methods is to provide virucidal efficacy against Murine Norovirus in addition to other viruses (enveloped and non-enveloped viruses), to ensure adequate disinfection against human norovirus.

A further object of the compositions and methods is a treatment option having a use solution pH, including those applied with a wipe, that does not require the use of personal protective equipment (PPE).

A still further object of the compositions and methods is to provide a synergistic combination of an anionic surfactant and at least one acid, wherein the acid can be a strong acid, a weak acid or combinations thereof.

A still further object is to provide both solid and liquid compositions, including solid compositions with a kit to make a saturated wipe composition.

Other objects, advantages and features of the present invention will become apparent from the following specification taken in conjunction with the accompanying drawings.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide methods of using a wipe composition comprising: contacting a wipe composition to a surface in need of treatment with a wipe substrate, wherein the wipe composition comprises at least one acid, wherein the acid comprises a strong acid, a weak acid, or combinations thereof and at least one anionic surfactant, wherein the composition has a pH of less than or equal to about 5, and wherein the method removes soils, hazy, streaky, and/or tacky residues from the surface without requiring a rinse step.

It is a further object, feature, and/or advantage of the present disclosure to provide a wipe composition kit comprising: a canister or container housing wipe substrates; and a solid concentrate composition comprising at least one acid, wherein the acid comprises a strong acid, a weak acid, or combinations thereof, at least one anionic surfactant, and a solidifying agent, wherein the concentrate composition when diluted has a pH of less than or equal to about 5.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the cleaning and polishing performance of a wipe composition compared to water or a dry cloth on tea-stained ceramic tiles.

FIG. 2 shows a soiled spoon before and after the wipe composition saturated wipe.

FIG. 3 shows soiled spoons and a soiled fork before and after the wipe composition saturated wipe.

FIG. 4 shows the cleaning and polishing performance of a wipe composition compared to water or a dry cloth on blue stained ceramic tiles.

FIG. 5 shows the cleaning and polishing performance of a wipe composition saturated wipe compared to water on lipstick and permanent marker on glass beakers.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present invention relates to wipe compositions and saturated wipes providing efficacy against microbial and viral pathogens while providing surface compatible and surface polishing formulations that do not leave hazy, streaky, or tacky residues on treated surfaces and do not require PPE. In some embodiments, the compositions provide no-rinse efficacy against both microbial and viral pathogens. In some embodiments, liquid concentrates, liquid ready-to-use, and solid compositions are disclosed for use to make wipe compositions and kits for wipe compositions.

The embodiments are not limited to particular compositions and methods of use thereof, which can vary and are understood by skilled artisans. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g., 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition. As referred to herein, antimicrobial compositions are further suitable for cidal activity against viral pathogens, including for example, Norovirus and Murine Norovirus, including use of EN14476 at 18° C.-25° C. (under clean or dirty conditions).

The term “biofilm,” as used herein, means an extracellular matrix in which a population of microorganisms are dispersed and/or form colonies. Biofilms are understood to be typically made of polysaccharides and other macromolecules, often referred to as exopolysaccharides, that are concentrated at an interface (usually solid/liquid) and act as a binding agent that surrounds such populations of microorganisms. Biofilms are further understood to include complex associations of cells, extracellular products and detritus (or non-living particulate organic material) that are trapped within the biofilm or released from cells within the biofilm. The term biofilm, as used herein, further refers to the ASTM definition of biofilm as an accumulation of bacterial cells immobilized on a substratum and embedded in an organic polymer matrix of microbial origin. Biofilms are understood to be a dynamic, self-organized accumulation of microorganisms and microbial and environmental by-products that is determined by the environment in which it lives.

As used herein, the term “cleaning” refers to a method used to facilitate or aid in soil removal, bleaching, microbial population reduction, rinsing, and any combination thereof.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “commercially acceptable cleaning performance” refers generally to the degree of cleanliness, extent of effort, or both that a typical consumer would expect to achieve or expend when using a cleaning product or cleaning system to address a typical soiling condition on a typical surface. This degree of cleanliness may, depending on the particular cleaning product and particular surface, correspond to a general absence of visible soils, or to some lesser degree of cleanliness. Cleanliness may be evaluated in a variety of ways depending on the particular product being used and the particular surface being cleaned, and normally may be determined using generally agreed industry standard tests or localized variations of such tests. In some embodiments, the methods providing virucidal efficacy also provide commercially acceptable cleaning performance while ensuring the formulations do not leave hazy, streaky, or tacky residues on treated surfaces.

As used herein, the term “corrosive” refers to an agent or composition that results in chemical attack, oxidation, discoloration, dimensional changes and/or weight loss of a surface and/or pitting of a surface. Various mechanisms of corrosion are disclosed in Corrosion

Basics, National Association of Corrosion Engineers, 1984, including for example, metal corrosion through a redox attack, attacking and penetrating the passivation layers of metal, pitting of surfaces, etc. Compositions that are non-corrosive beneficially do not cause or exhibit any chemical attack, oxidation, discoloration, dimensional and/or weight loss of a surface and/or pitting of a surface. Exemplary methodology for assessing corrosive or non-corrosive properties of a composition are illustrated in the Examples and can include weight assessment to measure surface changes and/or gloss measurements.

As used herein, the term “disinfectant” refers to an agent that kills all vegetative cells including most recognized pathogenic microorganisms. In an embodiment, a disinfectant according to U.S. standards can use the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is affected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

In an embodiment, a disinfectant according to EU standards is as set forth in DIRECTIVE 98/8/EC OF THE EUROPEAN PARLIAMENT AND OF THE COUNCIL of 16 Feb. 1998, and Guidance on the Biocidal Products Regulation Volume II Efficacy-Assessment and Evaluation (Parts B+C) Version 3.0 April 2018-ECHA (European Chemicals Agency), each of which are herein incorporated by reference in their entirety.

A disinfectant can include any one of four groups of biocidal products with five defined product types for products that reduces the number of microorganisms in or on an inanimate matrix-achieved by the irreversible action of a product. In an embodiment, the disinfectant products can be confirmed using a variety of recognized testing methods (CEN, OECD, ISO, etc.); see Guidance document, Appendices 2 and 4. According to various embodiments of the methods and compositions described herein, the EN1276 methodology was used to demonstrate bactericidal performance with a 5 log reduction requirement and the EN14476 methodology was used to demonstrate viricidal performance with a 4 log reduction requirement.

The term “hard surface” refers to a solid, substantially non-flexible surface. Hard surfaces may include for example, various ware (e.g. utensils, dishware, glassware) and the like. In embodiments, the hard surfaces are food contacting surfaces.

The term “improved cleaning performance” refers generally to achievement by a substitute cleaning product or substitute cleaning system of a generally greater degree of cleanliness or with generally a reduced expenditure of effort, or both, when using the substitute cleaning product or substitute cleaning system rather than the conventional cleaning product to address a typical soiling condition on a typical surface. This degree of cleanliness may, depending on the particular cleaning product and particular surface, correspond to a general absence of visible soils, along with treated surfaces that do not have hazy, streaky, or tacky residues.

The term “GSM” refers to the basis weight of a wipe composition measured in grams per square meter (gram/m²). Most commercially available wipe compositions have between about 20-100 GSM, or more often <40 GSM for synthetic substrates and >40 GSM for cellulose substrates, with variation between vendors expected.

The terms “include” and “including” when used in reference to a list of materials refer to but are not limited to the materials so listed.

As used herein, the term “instrument” refers to the various medical or dental instruments or devices that can benefit from cleaning/virucidal treatment as described herein.

As used herein, the term “virucidal” refers to an agent that reduces the number of viruses on a surface. In an embodiment, virucidal compositions will provide at least a 3-log order reduction, or preferably a 5-log order reduction, or more preferably a complete inactivation of viruses. These reductions can be evaluated using a procedure set out in ASTM E1053 Standard Test Method for Efficacy of Virucidal Agents Intended for Inanimate Environmental Surfaces; US standards are set forth in EPA 810.2200; EP standards are set forth in EN 14476, each of which are herein incorporated by reference in its entirety. The outlined log reductions can be achieved over various periods of time (which can vary according to contact time requirements set forth in various jurisdictions), including for example less than about 60 minutes, less than about 30 minutes, less than about 5 minutes, less than 1 minute, less than about 30 seconds, or even less than about 15 seconds. According to this reference a virucidal composition should provide a 99.9% reduction (3-log order reduction) for virucidal activity.

The term “virus”, as used herein refers to a type of microorganism that can include both pathogenic and non-pathogenic viruses. Pathogenic viruses can be classified into two general types with respect to the viral structure: enveloped viruses and non-enveloped viruses. Some well-known enveloped viruses include herpes virus, influenza virus; paramyxovirus, respiratory syncytial virus, corona virus, HIV, hepatitis B virus, hepatitis C virus and SARS-COV virus. Non-enveloped viruses, sometimes referred to as “naked” viruses, include the families Picornaviridae, Reoviridae, Caliciviridae, Adenoviridae and Parvoviridae. Members of these families include rhinovirus, poliovirus, adenovirus, hepatitis A virus, norovirus, papillomavirus, and rotavirus. It is known in the art that “enveloped” viruses are relatively sensitive and, thus, can be inactivated by commonly used disinfectants. In contrast, non-enveloped viruses are substantially more resistant to conventional disinfectants and are significantly more environmentally stable than enveloped viruses.

The term “norovirus” is meant to refer to the human norovirus (referred to simply as norovirus) which is in the family Caliciviridae, which is the leading cause of acute nonbacterial gastroenteritis. There are various surrogates commonly used for norovirus as to date, human norovirus cannot be grown in cell culture. Norovirus has a low infectious dose (10 to 100 virus particles) and environmental contamination prolongs outbreaks. Surfaces, serving dishes or containers, utensils, and food handled by ill persons who are not practicing adequate personal hygiene before preparing food may also contribute to illness. Feline calicivirus (FCV), from the genus Vesivirus, can be propagated in cell culture, it has been extensively studied as a surrogate for human norovirus in environmental survival and inactivation studies. However, FCV is transmitted by the respiratory route and is inactivated at a relatively low pH, and hence, it may not predict human norovirus environmental stability or inactivation. Mouse norovirus 1 (MNV-1) has been propagated in cell culture and causes a lethal infection in mice that presents as hepatitis, pneumonia, or inflammation of the nervous system and is therefore very different from the clinical presentation of the human norovirus; however, MNV-1 is shed in mouse feces and is commonly transmitted by the fecal-oral route. The genetic relatedness of MNV-1 to norovirus combined with its ability to survive under gastric pH levels (minimal loss of infectivity at pH 2) makes this virus a relevant surrogate for studying environmental survival of norovirus. The MNV-1 is able to survive low pH and is superior in acid tolerance in comparison to FCV.

As used herein, the term “sanitizer” refers to an agent that reduces the number of bacterial contaminants to safe levels as judged by public health requirements. In an embodiment, sanitizers for use in this invention will provide at least a 3-log reduction and more preferably a 5-log order reduction. These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soil” refers to polar or non-polar organic or inorganic substances including, but not limited to carbohydrates, proteins, fats, oils and the like. These substances may be present in their organic state or complexed to a metal to form an inorganic complex. Types of soils that can be cleaned with the compositions include but are not limited to, those that include hard water spots, food soils, cosmetic soils, and combinations thereof. Exemplary soils include food items, such as milk, soups, tea, and the like; cosmetics, such as lipstick, mascara, sunscreen, foundation, and the like; permanent markers, hard water residue/deposits, such as carbonate spots, and the like. Soils can further include “soil residue” where an initial cleaning and/or sanitizing step has taken place, yet residues of the soils remain and are in need of removal, such as with the wipe compositions described herein.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “threshold agent” refers to a compound that inhibits crystallization of water hardness ions from solution, but that need not form a specific complex with the water hardness ion. Threshold agents include but are not limited to a polyacrylate, a polymethacrylate, an olefin/maleic copolymer, and the like.

As used herein, the term “ware” refers to items such as eating and cooking utensils, dishes, glasses, and other hard surfaces. As used herein, the term “warewashing” refers to washing, cleaning, or rinsing ware. The term “ware” generally refers to items such as eating and cooking utensils, dishes, glasses, and other hard surfaces. Ware also refers to items made of various substrates, including glass, ceramic, china, crystal, metal, plastic or natural substances such, but not limited to clay, bamboo, hemp and the like. Types of metals that can be cleaned with the compositions include but are not limited to, those that include aluminum, copper, brass, and stainless steel. Types of plastics that can be cleaned with the compositions include but are not limited to, those that include polypropylene (PP), high density polyethylene (HDPE), low density polyethylene (LDPE), polyvinyl chloride (PVC), syrene acrylonitrile (SAN), polycarbonate (PC), melamine formaldehyde resins or melamine resin (melamine), acrilonitrile-butadiene-styrene (ABS), and polysulfone (PS). Other exemplary plastics that can be cleaned using the compounds and compositions include polyethylene terephthalate (PET) polystyrene polyamide.

As used herein, the term “waters” includes various water sources. Water temperatures can range from about 40° F.-160° F., about 60° F.-140° F., or about 70° F.-140° F. Food process or transport waters include produce transport waters (e.g., as found in flumes, pipe transports, cutters, slicers, blanchers, retort systems, washers, and the like), belt sprays for food transport lines, boot and hand-wash dip-pans, third-sink rinse waters, and the like. Waters also include domestic and recreational waters such as pools, spas, recreational flumes and water slides, fountains, and the like.

The term “water soluble” refers to a compound that can be dissolved in water at a concentration of more than 1 wt. %. The terms “sparingly soluble” or “sparingly water soluble” refer to a compound that can be dissolved in water only to a concentration of 0.1 to 1.0 wt. %. The term “water insoluble” refers to a compound that can be dissolved in water only to a concentration of less than 0.1 wt. %.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the method steps, components and ingredients of the present invention as well as other method steps, components and ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Wipe Compositions

Exemplary ranges of the wipe compositions are shown in Table 1 showing liquid concentrate formulations, Table 2 showing liquid ready to use (RTU) formulations, and Table 3 showing solid formulations, each on a weight percentage basis.

TABLE 1
(liquid concentrate)

| | First | Second | Third | Fourth |
|---|---|---|---|---|
| | Exemplary | Exemplary | Exemplary | Exemplary |
| | Range wt- | Range wt- | Range wt- | Range wt- |
| Material | % | % | % | % |
| Acid(s) | 1-80 | 5-80 | 10-70 | 20-70 |
| Anionic Surfactant | 0.1-50 | 1-50 | 5-45 | 10-40 |
| Additional Functional | 0-20 | 1-20 | 1-15 | 1-10 |
| Ingredients | | | | |
| Water | Remainder | Remainder | Remainder | Remainder |
| | to 100% | to 100% | to 100% | to 100% |

TABLE 2
(liquid ready to use (RTU))

| | First | Second | Third | Fourth |
|---|---|---|---|---|
| | Exemplary | Exemplary | Exemplary | Exemplary |
| | Range wt- | Range wt- | Range wt- | Range wt- |
| Material | % | % | % | % |
| Acid(s) | 0.025-38 | 0.05-32 | 0.1-29 | 0.4-26 |
| Anionic Surfactant | 0.025-38 | 0.025-26 | 0.025-13 | 0.05-6.4 |
| Additional Functional | 0-38 | 0-19 | 0-13 | 0-6 |
| Ingredients | | | | |
| Water | Remainder | Remainder | Remainder | Remainder |
| | to 100% | to 100% | to 100% | to 100% |

TABLE 3
(solid)

| | First | Second | Third | Fourth |
|---|---|---|---|---|
| | Exemplary | Exemplary | Exemplary | Exemplary |
| | Range wt- | Range wt- | Range wt- | Range wt- |
| Material | % | % | % | % |
| Acid(s) | 1-80 | 5-80 | 10-70 | 20-70 |
| Anionic Surfactant | 0.1-50 | 1-50 | 5-45 | 10-40 |
| Additional Functional | Remainder | Remainder | Remainder | Remainder |
| Ingredients (including | to 100% | to 100% | to 100% | to 100% |
| hardening agents or | | | | |
| solidifying agents, | | | | |
| surfactants, etc.) | | | | |

The wipe compositions may include concentrate compositions which can be diluted to form use compositions or may be provided as ready to use (RTU) compositions. The solid compositions provide a use solution that is a dilutable liquid concentrate which can be further diluted to form use compositions or RTU compositions. Beneficially, the compositions overcome a limitation of the prior art in that dilutable concentrates can be provided. In general, a concentrate refers to a composition that is intended to be diluted with water to provide a use solution that contacts an object to provide the desired cleaning, antimicrobial efficacy, or the like. The wipe composition that contacts the articles can be referred to as a concentrate or a use composition (or use solution including an RTU composition) dependent upon the formulation employed in the methods described herein. It should be understood that the concentration of the acids, anionic surfactant(s), and any additional functional ingredients, in the composition will vary depending on whether the composition is provided as a concentrate or as a use solution. One skilled in the art can adjust % by weight of the compositions to arrive at a composition having a different dilution rate, which is within the scope of the disclosed compositions.

A use solution may be prepared from the concentrate by diluting the liquid concentrate with water at a dilution ratio that provides a use solution having desired antimicrobial and virucidal properties. The water that is used to dilute the solid or liquid concentrate to form the use composition can be referred to as water of dilution or a diluent and can vary from one location to another. The typical dilution factor is between approximately 1 and approximately 10,000. In an embodiment, the solid or liquid concentrate is diluted at a ratio of between about 1:10 and about 1:10,000 solid or liquid concentrate to water, between about 1:10 and about 1:1,000 solid or liquid concentrate to water, or between about 1:10 and about 1:510 solid or liquid concentrate to water. In another embodiment, a concentrate can be diluted at a rate of from about ⅛ oz./gal. to about 12 oz./gal., from about ¼ oz./gal. to about 1 oz./gal., or from about ½ oz./gal. to about 1 oz./gal while providing sanitizing efficacy.

In an embodiment, a diluted use solution is made from about a 0.5% to about a 3% by weight dilution of the liquid concentrate composition.

In an embodiment, a liquid use composition has between about 0.025 wt-% to about 38 wt-%, between about 0.05 wt-% to about 38 wt-%, between about 0.05 wt-% to about 32 wt-%, between about 0.1 wt-% to about 30 wt-%, between about 0.1 wt-% to about 29 wt-%, between about 0.4 wt-% to about 26 wt-% of acid(s), or any range therebetween. In an embodiment, a liquid use composition has between about 0.025 wt-% to about 38 wt-%, between about 0.025 wt-% to about 30 wt-%, between 0.025 wt-% to about 26 wt-%, between about 0.025 wt-% to about 20 wt-%, between about 0.025 wt-% to about 15 wt-%, between about 0.025 wt-% to about 13 wt-%, between about 0.05 wt-% to about 10 wt-%, between about 0.05 wt-% to about 6.4 wt-% of anionic surfactant(s), or any range therebetween.

In an embodiment, a liquid use composition or a RTU composition provides up to about 6000 ppm anionic surfactant, or from about 10 ppm to about 6000 ppm anionic surfactant. In further embodiments, a liquid composition or a RTU composition provide anionic surfactants at a concentration to maintain food contact approvals.

In an embodiment, the liquid concentrate composition, RTU compositions or a concentrate compositions diluted to provide a use solution pH from about 1.5 to about 5, from about 2 to about 5, from about 2.0 to about 3.5, or from about 2.0 to about 5, including ranges therebetween.

The liquid compositions can be provided in various forms well appreciated by those skilled in the art. The compositions can also be manufactured to include a saturated wipe, such as a cellulose based or cloth substrate having the liquid compositions saturated thereon.

The solid compositions can be provided in various forms well appreciated by those skilled in the art. The compositions can be manufactured to include a solid block, including pressed, extruded, cast, tableted, or the like. Solids can also include granulates and powders, including flowable powders. In certain embodiments the solids can also include applicable packaging (e.g. film, such as a PVA film). Beneficially, the solid compositions including a combination of acids and anionic surfactants provide efficacious and stable solid alternatives to extruded solids using quaternary ammonium compounds. Various forms and sizes of the solids can be included in addition to solid blocks, including for example, pucks, tablets, and the like. Various techniques for forming the solids can be employed, including for example use of a fluid bed and/or agglomeration to form solids from the liquids.

The solid composition may take forms as well as sizes. In an exemplary embodiment, solids can have a weight of between approximately 50 grams and approximately 250 grams, approximately 100 grams or greater, and between approximately 1 and approximately 10 kilograms. In certain embodiments, the solid compositions can include a unit dose, such as a tablet. A unit dose refers to a solid composition unit sized so that the entire unit is used during a single application of use (e.g. dilution to provide a wipe composition or RTU composition to saturate a wipe or a desired quantity of wipes). When the solid composition is provided as a unit dose, it is typically provided as a cast solid, an extruded pellet, or a tablet having a size of between approximately 1 gram and approximately 50 grams. In other embodiments, the solid composition is provided in the form of a multiple-use solid, such as a block or a plurality of pellets, and can be repeatedly used to generate wipe compositions for multiple applications or saturating a plurality of wipes intended for use of a longer period of time (e.g. filling a canister or container of wipes to provide pre-saturated wipes for cleaning applications).

In certain embodiments, the solid composition is provided as a pressed solid, cast solid, an extruded block, or a tablet having a mass of between approximately 5 grams and approximately 10 kilograms. In certain embodiments, a multiple-use form of the solid composition has a mass between approximately 1 kilogram and approximately 10 kilograms.

The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the composition under the expected conditions of storage and use of the solid cleaning composition. In general, it is expected that the composition will remain in solid form when exposed to temperatures of up to approximately 100° F., up to approximately 120° F., or up to approximately 125° F. while maintaining physical and dimensional stability. The dimensional stability of the solid composition is confirmed by a growth exponent of less than about 3% if heated at a temperature up to approximately 100° F. (40° C.), up to approximately 120° F. (50° C.), or up to approximately 140° F. (60° C.) for an extended period of time, such as at least 30 minutes, or at least one hour, up to two weeks, up to four weeks, up to six weeks, or up to eight weeks, and at a humidity between about 40-65%.

### Acids

The wipe compositions include at least one acid, which can include a strong or weak acid, and in some embodiments organic acid(s). In embodiments, the wipe compositions include two acids. In such an aspect of a combination of acids, the acids can be a combination of a weak acid and a strong acid. In another aspect of a combination of acids, the acids can be a combination of two weak acids or two strong acids. For the purposes of this invention, an acid is a component that can be added to an aqueous system and result in a pH less than 7. Strong acids that can be used are acids which substantially dissociate an aqueous solution. “Weak” organic and inorganic acids are acids or acid components in which the first dissociation step of a proton from the acid moiety does not proceed essentially to completion when the acid is dissolved in water at ambient temperatures at a concentration within the range useful to form the present compositions.

Exemplary strong acids suitable for use in the compositions include methane sulfonic acid, sulfuric acid, sodium hydrogen sulfate, phosphoric acid, phosphonic acid, nitric acid, sulfamic acid, hydrochloric acid, trichloroacetic acid, trifluoroacetic acid, toluene sulfonic acid, glutamic acid, and the like; alkane sulfonic acid, such as methane sulfonic acid, ethane sulfonic acid, linear alkyl benzene sulfonic acid, xylene sulfonic acid, cumene sulfonic acid and the like. In a preferred aspect, the compositions include a strong acid having a pKa less than or equal to about 2.5 to beneficially provide the acidic use compositions having a pH less than about 5, or preferably less than about 3. In an embodiment, the compositions include a strong acid in combination with the anionic surfactant, and optionally include a weak acid.

Exemplary weak acids suitable for use in the compositions including alpha hydroxycarboxylic acid, such as lactic acid, citric acid, glycolic acid, tartaric acid, malic acid, gluconic acid, and the like; carboxylic acids, such as formic acid, acetic acid, propionic acid and the like; other common organic acids such as ascorbic acid, oxalic acid, levulinic acid, etc. could also be used. In a preferred aspect, the compositions include a weak acid having a pKa greater than about 2.5 to beneficially provide the acidic use compositions having a pH less than about 5, or preferably less than about 3. In an embodiment, the compositions include a weak acid in combination with the anionic surfactant, and optionally include a strong acid.

In certain embodiments, a combination of a strong acid with a weak acid result in surprisingly increased antimicrobial and virucidal efficiency. In an embodiment, the at least one acid is a weak acid. In an embodiment, the acids comprise lactic acid and/or citric acid. Without being limited to a particular mechanism of action, it may be desirable to have a buffered acidic composition. For example, if a surface in need of treatment is not sufficiently cleaned the compositions have a buffered composition by virtue of a combination of weak and strong acids will beneficially be able to support inactivation of pH sensitive organisms.

In an embodiment, a concentrate liquid or solid composition has between about 1 wt-% to about 80 wt-%, between about 5 wt-% to about 80 wt-%, between about 10 wt-% to about 80 wt-%, between about 15 wt-% to about 80 wt-%, between about 15 wt-% to about 75 wt-%, between about 20 wt-% to about 75 wt-%, between about 20 wt-% to about 70 wt-% of acid(s). In addition, without being limited according to the disclosure, all ranges recited are inclusive of the numbers defining the range and include each integer within the defined range.

In certain aspects, the concentrate liquid or solid wipe compositions include from about 0.01 wt-% to about 30 wt-% of a strong acid, from about 0.1 wt-% to about 30 wt-% of a strong acid, from about 1 wt-% to about 30 wt-% of a strong acid, from about 1 wt-% to about 25 wt-% of a strong acid, from about 5 wt-% to about 25 wt-% of a strong acid, or from about 5 wt-% to about 20 wt-% of a strong acid. In addition, without being limited according to the invention, all ranges recited are inclusive of the numbers defining the range and include each integer within the defined range.

In certain aspects, the concentrate liquid or solid wipe compositions include from about 0.1 wt-% to about 50 wt-% of a weak acid, from about 1 wt-% to about 50 wt-% of a weak acid, from about 1 wt-% to about 50 wt-% of a weak acid, from about 15 wt-% to about 50 wt-% of a weak acid, from about 20 wt-% to about 50 wt-% of a weak acid, or from about 20 wt-% to about 45 wt-% of a weak acid. In addition, without being limited according to the invention, all ranges recited are inclusive of the numbers defining the range and include each integer within the defined range.

In certain aspect, the concentrate liquid or solid wipe compositions include from about 0.1 wt-% to about 30 wt-% of a strong acid, from about 1 wt-% to about 30 wt-% of a strong acid, from about 1 wt-% to about 25 wt-% of a strong acid, from about 5 wt-% to about 25 wt-% of a strong acid, or from about 5 wt-% to about 20 wt-% of a strong acid, in combination with a weak acid, wherein the compositions include from about 1 wt-% to about 50 wt-% of a weak acid, from about 10 wt-% to about 50 wt-% of a weak acid, from about 15 wt-% to about 50 wt-% of a weak acid, from about 20 wt-% to about 50 wt-% of a weak acid, or from about 20 wt-% to about 45 wt-% of a weak acid. In addition, without being limited according to the invention, all ranges recited are inclusive of the numbers defining the range and include each integer within the defined range.

In an embodiment, the liquid RTU wipe compositions or a use solution include from about 0.025 wt-% to about 38 wt-%, between about 0.05 wt-% to about 38 wt-%, between about 0.05 wt-% to about 32 wt-%, between about 0.1 wt-% to about 30 wt-%, between about 0.1 wt-% to about 29 wt-%, between about 0.4 wt-% to about 26 wt-% of acid(s). In addition, without being limited according to the invention, all ranges recited are inclusive of the numbers defining the range and include each integer within the defined range.

### Organic Acids

The wipe compositions including at least one acid can in some embodiments include at least one organic acid, or at least two organic acids, and particularly at least two carboxylic acids. Preferably, the organic acid(s) provide a pH of less than or equal to about 5 in a RTU or use solution of the composition. As used herein, organic acid refers to a compound containing one or more carboxyl groups (—COOH). The carboxyl group is a functional group consisting of a carbon atom with a double bond to an oxygen atom and a single bond to a hydroxyl group (—OH). Organic acids are typically weak acids, meaning they do not completely dissociate in solution and generally have a pH less than 7. In an embodiment, the compositions include one or more organic acids having a pKa greater than about 2.5 to beneficially provide use solutions having a pH less than about 6, less than about 5, less than about 4, or preferably less than about 3.

Exemplary organic acids suitable for use in the compositions include, without limitation, carboxylic acids, phenolic acids, hydroxy acids, sulfonic acids, fatty acids, or combinations thereof.

Carboxylic acids are a class of organic compounds that contain at least one carboxyl group (—COOH) in their molecular structure. The carboxyl group consists of a carbonyl group (C═O) and a hydroxyl group (—OH) attached to the same carbon atom. The term “carboxylic acid” also includes hydroxy acids, polycarboxylic acids, and fatty acids. Examples of suitable carboxylic acids include, without limitation, acetic acid, citric acid, formic acid, butyric acid, benzoic acid, propionic acid, tartaric acid, lactic acid, oleic acid, palmitic acid, or a combination thereof. In a preferred embodiment, the compositions comprise a first carboxylic acid and a second carboxylic acid.

Hydroxy acids are a sub-class of carboxylic acids that consist of a carboxylic acid with a hydroxyl group substituent on the adjacent alpha carbon atom. Alpha hydroxy carboxylic acids consist of a carboxylic acid with a hydroxyl group substituent on the adjacent alpha carbon. Some examples of suitable alpha-hydroxy acids include, without limitation, glycolic acid, lactic acid, malic acid, mandelic acid, citric acid, tartaric acid, or a combination thereof.

Polycarboxylic acids are a type of carboxylic acid that contain multiple carboxylic acid functional groups. Some common examples of suitable polycarboxylic acids include citric acid, oxalic acid, succinic acid, adipic acid, malic acid, tartaric acid, or a combination thereof.

Fatty acids are long-chain carboxylic acids that are commonly found in various natural fats and oils. Suitable fatty acids include, for example, palmitic acid, stearic acid, oleic acid, linoleic acid, arachidonic acid, or a combination thereof.

Phenolic acids are a class of organic compounds that contain a phenolic ring and a carboxylic acid group. Some examples of suitable phenolic acids include, without limitation, caffeic acid, ferulic acid, gallic acid, protocatechuic acid, vanillic acid, or a combination thereof.

Sulfonic acids are a class of organic compounds that contain a sulfonic acid group (—SO₃H) attached to a carbon atom. Some examples of sulfonic acids include, without limitation, benzenesulfonic acid, toluene sulfonic acid, methane sulfonic acid, sulfamic acid, or a combination thereof.

In sum, examples of suitable acids include, without limitation, acetic acid, citric acid, formic acid, butyric acid, benzoic acid, propionic acid, tartaric acid, lactic acid, oleic acid, palmitic acid, glycolic acid, lactic acid, malic acid, mandelic acid, citric acid, tartaric acid, palmitic acid, stearic acid, oleic acid, linoleic acid, arachidonic acid, caffeic acid, ferulic acid, gallic acid, protocatechuic acid, vanillic acid, benzenesulfonic acid, toluene sulfonic acid, methane sulfonic acid, sulfamic acid, citric acid, oxalic acid, succinic acid, adipic acid, malic acid, tartaric acid, or a combination thereof.

In a preferred embodiment, the compositions comprise a first organic acid and a second organic acid. In a further preferred embodiment, the compositions comprise a carboxylic acid and a polycarboxylic acid. In a still further preferred embodiment, the carboxylic acid is lactic acid and the polycarboxylic acid is citric acid.

In an embodiment, a concentrate liquid or solid composition has between about 1 wt-% to about 80 wt-%, between about 5 wt-% to about 80 wt-%, between about 10 wt-% to about 80 wt-%, between about 15 wt-% to about 80 wt-%, between about 15 wt-% to about 75 wt-%, between about 20 wt-% to about 75 wt-%, between about 20 wt-% to about 70 wt-% of organic acid(s). In addition, without being limited according to the disclosure, all ranges recited are inclusive of the numbers defining the range and include each integer within the defined range.

In an embodiment, the liquid RTU wipe compositions or a use solution include from about 0.025 wt-% to about 38 wt-%, between about 0.05 wt-% to about 38 wt-%, between about 0.05 wt-% to about 32 wt-%, between about 0.1 wt-% to about 30 wt-%, between about 0.1 wt-% to about 29 wt-%, between about 0.4 wt-% to about 26 wt-% of organic acid(s) In addition, without being limited according to the invention, all ranges recited are inclusive of the numbers defining the range and include each integer within the defined range.

### Anionic Surfactants

The wipe compositions include at least one anionic surfactant. In embodiments, the wipe compositions include two anionic surfactants. In embodiments, the wipe compositions include more than two anionic surfactants. Anionic surfactants are surface active substances which are categorized by the negative charge on the hydrophobe; or surfactants in which the hydrophobic section of the molecule carries no charge unless the pH is elevated to neutrality or above (e.g., carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

Anionic sulfonate surfactants suitable for use in the compositions also include alkyl sulfonates, the linear and branched primary and secondary alkyl sulfonates, and the aromatic sulfonates with or without substituents. In an aspect, sulfonates include sulfonated carboxylic acid esters. In an aspect, suitable alkyl sulfonate surfactants include C8-C22 alkyl sulfonates, or preferably C10-C22 alkyl sulfonates. In an exemplary aspect, the anionic alkyl sulfonate surfactant is a linear alkyl benzene sulfonic acid (LAS), such as for example linear dodecylbenzene sulfonic acid (DBSA). In a preferred embodiment employing LAS as the anionic surfactant, the compositions are most effective at pH 3.0 or below.

In another exemplary aspect, the anionic alkyl sulfonate surfactant is an alpha olefin sulfonate or its salts. Alpha olefin sulfonates are available as aqueous solutions, powders or as a solid anhydrous product. Preferred anionic sulfonates include C8-C22 alpha olefin sulfonates, or C8-C16 alpha olefin sulfonates. Beneficially, alpha olefin sulfonate surfactants are stable in hard water. They are clear stable solutions which is particularly appealing for customer use.

Anionic sulfate surfactants suitable for use in the compositions also include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C5-C17 acyl-N—(C1-C4 alkyl) and —N—(C1-C2 hydroxyalkyl) glucamine sulfates, and sulfates of alkylpolysaccharides such as the sulfates of alkylpolyglucoside (e.g. alkyl (C8 and C10) polyglucoside commercially available as APG 215), and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). In an embodiment, anionic surfactants in the compositions include sulfates of alkylpolyglucoside and/or alkyl sulfate such as sodium lauryl sulfate.

Additional anionic surfactants suitable for the compositions include anionic carboxylate surfactants, those which have a carboxylic acid or an alpha hydroxyl acid group. Anionic carboxylate surfactants suitable for use in the compositions also include carboxylic acids (and salts), such as alkanoic acids (and alkanoates), ester carboxylic acids (including sulfonated carboxylic acid esters), ether carboxylic acids, sulfonated fatty acids, such as sulfonated oleic acid, and the like. In an aspect, suitable ester carboxylic acids include alkyl succinates, such as for example dioctyl sulfosuccinate. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula: R—O—(CH₂CH₂O)ₙ(CH₂)ₘ—CO₂X in which R is a C8 to C22 alkyl group or

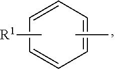

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1. In other embodiments, R is

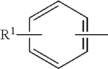

and R¹ is a C₆-C₁₂ alkyl group. In still yet other embodiments, R¹ is a C₉ alkyl group, n is 10 and m is 1.

In some embodiments the alkyl ether carboxylate or alkyl ether carboxylic acid is the anionic surfactant. Alkyl ether carboxylic acids have the following formula: R—(CH₂CH₂O)ₙ—CH₂COOH, wherein R is a C₆ to C₁₁ alkyl group, and n is an integer of 1-6, or preferably n is an integer of 4-6. In some embodiments, R is a C₆-C₁₀ alkyl group, n is an integer of 4-5. Exemplary alkyl ether carboxylic acids include capryleth-4-carboxlyic acid (where R is C8 alkyl group and n is 4) and capryleth-6-carboxlyic acid (where R is C₈ alkyl group and n is 5).

In some embodiments the alcohol ether carboxylate having the following formula: R—O—(CH₂CH₂O)ₙ(CH₂)ₘ—CO₂X, wherein R is a C₈ to C₂₂ alkyl group, or preferably a C₈ to C₁₂ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₂ alkyl group. In some embodiments, R is a C₈-C₁₂ alkyl group, n is 4, and m is 1.

Another class of anionic surfactant include the alpha sulfonated carboxylic acid esters, such as MC or PC-48 from Stepan.

In an embodiment, a concentrate liquid or solid composition has between about 0.1 wt-% to about 50 wt-%, between about 0.5 wt-% to about 50 wt-%, between about 1 wt-% to about 50 wt-%, between about 5 wt-% to about 50 wt-%, between about 5 wt-% to about 45 wt-%, between about 10 wt-% to about 45 wt-%, between about 10 wt-% to about 40 wt-% of anionic surfactant(s). In addition, without being limited according to the invention, all ranges recited are inclusive of the numbers defining the range and include each integer within the defined range.

In an embodiment, the liquid RTU wipe compositions or a use solution include from about 0.025 wt-% to about 38 wt-%, between about 0.025 wt-% to about 30 wt-%, between 0.025 wt-% to about 26 wt-%, between about 0.025 wt-% to about 20 wt-%, between about 0.025 wt-% to about 15 wt-%, between about 0.025 wt-% to about 13 wt-%, between about 0.05 wt-% to about 10 wt-%, between about 0.05 wt-% to about 6.4 wt-% of anionic surfactant(s). In addition, without being limited according to the invention, all ranges recited are inclusive of the numbers defining the range and include each integer within the defined range.

### Additional Functional Ingredients

The components of the wipe compositions can further be combined with various additional functional components. In some embodiments, the wipe composition including the at least one acid and at least one anionic surfactant make up a large amount, or even substantially all of the total weight of the composition. For example, in some embodiments few or no additional functional ingredients are included therein (other than water).

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In preferred embodiments, the compositions do not include quaternary ammonium compounds. In additional embodiments, the compositions do not include conventional Norovirus actives, including for example, ethanol, silver citrate, and/or electrolytic chlorine. In additional embodiments, the compositions do not include alcohols and/or other organic solvents to beneficially provide a non-flammable product. In certain additional embodiments, the compositions do not include nonionic surfactants and/or additional surfactants.

In other embodiments, the compositions may include fatty acid esters, defoaming agents, solidifying agents, wetting agents, anti-redeposition agents, solubility modifiers, dispersants, rinse aids, metal protecting agents, stabilizing agents, corrosion inhibitors, sequestrants and/or chelating agents, threshold agent, fragrances and/or dyes, rheology modifiers or thickeners, hydrotropes or couplers, buffers, solvents, sensor indicators, and the like.

### Fatty Acid Esters

In some embodiments, the compositions include a fatty acid ester. A fatty acid ester (FAE) is an ester resulting from the combination of a fatty acid with an alcohol. Examples of fatty acid esters can include sulfonated fatty acid esters, C6-C24 fatty acid ester ethoxylates, propoxylates or glycerides, or preferably C8-C12 fatty acid ester ethoxylates, propoxylates or glycerides. An example of a C6-C24, namely a C8-C10 fatty acid ester glycerides include octanoic/decanoic esters of glycerol. Still further examples of fatty acid esters can include glycerides (including monoglycerides, diglycerides, and triglycerides) when the alcohol is glycerol, sorbitan fatty acid esters (i.e. sorbitan sugar esters including for example sorbitan monooleate, sorbitan monooleatepolyoxyethylene ether), sorbitol fatty acid esters, polyethylene glycol fatty acid esters (e.g. tall oil fatty acids), polyglycerol fatty acid esters and the like.

Commercially-available fatty acid esters include for example, Stepan GCC-Mild, Stepan 108, Tween 20, etc. For example, polyoxyethylene sorbitan fatty acid esters can be Tween 20, Tween 40, Tween 60 and Tween 80, while the sorbitan fatty acid esters can be Span 20, Span 40, Span 60 and Span 80.

In some embodiments, the compositions include about 0 wt-% to about 30 wt-%, between about 0 wt-% to about 20 wt-%, between about 1 wt-% to about 20 wt-%, between about 5 wt-% to about 15 wt-% fatty acid ester.

### Additional Surfactants

In some embodiments, the compositions include an additional surfactant. Surfactants suitable for use with the compositions include, but are not limited to, nonionic surfactants, amphoteric surfactants, and/or zwitterionic surfactants. In some embodiments, the compositions include about 0 wt-% to about 40 wt-%, between about 0.1 wt-% to about 38 wt-%, between about 1 wt-% to about 20 wt-%, between about 1 wt-% to about 15 wt-% additional surfactant, or between about 1 wt-% to about 6 wt-% additional surfactant.

### Nonionic Surfactants

Suitable nonionic surfactants suitable for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

In an exemplary aspect, a nonionic surfactant available on the market under the trade name of “Pluronic” is included as an additional surfactant in the compositions. These compounds are formed by condensing ethylene oxide with a hydrophobic base formed by the condensation of propylene oxide with propylene glycol. The hydrophobic portion of the molecule has a molecular weight of from about 1,500 to 1,800. The addition of polyoxyethylene radicals to this hydrophobic portion tends to increase the water solubility of the molecule as a whole and the liquid character of the products is retained up to the point where the polyoxyethylene content is about 50 percent of the total weight of the condensation product.

The semi-polar type of nonionic surface active agents is another class of nonionic surfactant useful in compositions of the present invention. Semi-polar nonionic surfactants include the amine oxides, phosphine oxides, sulfoxides and their alkoxylated derivatives.

Amine oxides are tertiary amine oxides corresponding to the general formula:

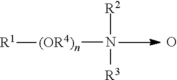

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide.

Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2)69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention generally have the general formula:

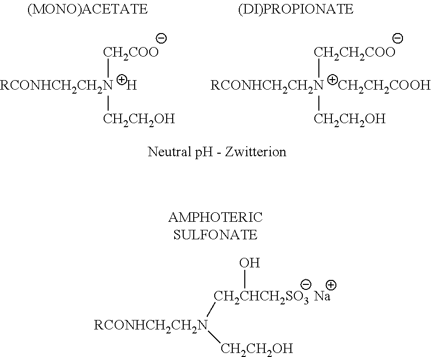

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺ (CH₂—CH₂—CO₂Na)₂—CH₂—CH₂—OH or C₁₂-alkyl-C(O)—N(H)—CH₂—CH₂—N⁺ (CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

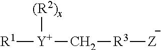

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di (2 (2-hydroxyethyl)-N(2-hydroxydodecyl) ammonio]-butane-1-carboxylate; 3-[S-ethyl-S-(3-dodecoxy-2-hydroxypropyl) sulfonio]-propane-1-phosphate; 3-[P,P-dimethyl-P-dodecylphosphonio]-propane-1-phosphonate; and S [N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

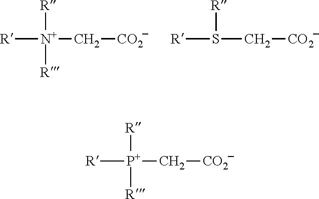

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present invention include those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references is herein incorporated in their entirety.

In an embodiment, the compositions of the present invention include a betaine. For example, the compositions can include cocoamido propyl betaine.

### Defoaming Agents

Defoaming agents can also be included in the compositions. Generally, defoamers which can be used in accordance with the invention preferably include alcohol alkoxylates and EO/PO block copolymers. Defoamers can also include polyalkylene glycol condensates and propyl glycols, including polypropyl glycol. In some embodiments, the compositions can include antifoaming agents or defoamers which are of food grade quality given the application of the methods. To this end, one of the more effective antifoaming agents includes silicones. Silicones such as dimethyl silicone, glycol polysiloxane, methylphenol polysiloxane, trialkyl or tetralkyl silanes, hydrophobic silica defoamers and mixtures thereof can all be used in defoaming applications. These defoamers can be present at a concentration range from about 0.01 wt-% to 20 wt-%, 0.01 wt-% to 20 wt-%, from about 0.01 wt-% to 5 wt-%, or from about 0.01 wt-% to about 1 wt-%.

### Solidifying Agents

Solidifying agents (also referred to as hardening agents) can also be included in the solid compositions. Solidifying agents can include a compound or system of compounds, organic or inorganic, which significantly contribute to the uniform solidification of the solid composition. The solidifying agents should be capable of forming a homogeneous matrix with the active components of the solid composition when mixed and solidified to provide a uniform dissolution of the actives from the solid composition during use.

An exemplary solidifying agent includes urea. Urea may be in the form of prilled beads or powder. Prilled urea is generally available from commercial sources as a mixture of particle sizes ranging from about 8-15 U.S. mesh, as for example, from Arcadian Sohio Company, Nitrogen Chemicals Division. A prilled form of urea is preferably milled to reduce the particle size to about 50 U.S. mesh to about 125 U.S. mesh, particularly about 75-100 U.S. mesh, preferably using a wet mill such as a single or twin-screw extruder, a Teledyne mixer, a Ross emulsifier, and the like.

Additional solidifying agents may be an organic hardening agent, including for example: a polyethylene glycol (PEG) compound, suitable examples including solid polyethylene glycols of the general formula H(OCH2CH₂)nOH, where n is greater than 15, particularly approximately 30 to approximately 1700, such as PEG 4000, PEG 1450, and PEG 8000, among others. Still further, PEG can include varying molecular weights, for example, molecular weight of about 1,400 to about 30,000. In certain embodiments, the solidifying agent includes or is solid PEG, for example PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX.

Additional solidifying agents may be an inorganic hardening agent, including for example: hydratable inorganic salts, including, but not limited to carbonates, sulfates and bicarbonates, which may be an alkali metal or alkali earth metal salt. Suitable salts include lithium, sodium, potassium, calcium, magnesium, iron, strontium, zinc, manganese, lanthanum, titanium, gallium, aluminum, cobalt, copper, molybdenum, rhenium, rhodium, scandium, tin and zirconium. Suitable metal salts include sodium, lithium, potassium salts including, but not limited to sulfates, chlorides, phosphates, acetates, nitrates, and carbonates. Particularly useful metals salts include lithium, sodium and potassium sulfates, chlorides and acetates. The following patents disclose various combinations of solidification, binding and/or hardening agents that can be utilized in the solid compositions of the present invention. The following U.S. patents are incorporated herein by reference in their entirety: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

Still further, solidifying agents can include polymers and thickeners include natural gums such as xanthan gum, guar gum, or other gums from plant mucilage; polysaccharide based thickeners, such as alginates, starches, and cellulosic polymers (e.g., carboxymethyl cellulose); solid EO/PO block copolymers; polyacrylates; and hydrocolloids. In an embodiment, the thickener does not leave contaminating residue on the surface of an object. For example, the thickeners or gelling agents can be compatible with food or other sensitive products in contact areas.

The solidifying agents can be included in the solid compositions at range from about 0 wt-% to 70 wt-%, 0 wt-% to 50 wt-%, 0.01 wt-% to 30 wt-%, from about 0.01 wt-% to 20 wt-%, or from about 1 wt-% to about 20 wt-%.

### Wipe Substrate

In embodiments, use solutions or RTU solutions of the wipe compositions are saturated onto a wipe substrate derived from cellulosic fiber wipe substrate. The terms “wipe” and “substrate” may be used interchangeably herein. The term “wipe composition” refers to a wipe substrate saturated with the use solution or RTU solution. Cellulosic fibers can include plant-based fibers that are natural fibers (also referred to as regenerative fibers). Examples of cellulosic fiber include pulp fibers, cellulose fibers and regenerated cellulose fibers (e.g., viscose or also referred to as rayon, and lyocell or also referred to as tencel). Pulp fibers are smaller, shorter fibers. Regenerated fibers are pulp that are prepared, dissolved, and extruded (i.e., reprocessed) to create longer fibers or a continuous fiber, where beneficially the chemical nature of the derivative is retained after the fiber formation process.

The wipe substrates referred to herein include cellulosic and modified cellulose fibers comprising lyocell and viscose, which is understood to include regenerative cellulose fibers comprising lyocell and viscose. Both viscose and lyocell are stronger than pulp. However, lyocell is known to be a stronger material than viscose due to its more uniform geometry and production method.

In preferred embodiments, the wipe substrate is derived from cellulosic fibers and comprises, consists of, or consists essentially of lyocell and viscose. Viscose is a treated pulp or cellulose fiber, such as treated with sodium hydroxide and carbon disulfide. Lyocell fibers are solvent extruded for increased mobility and alignment of the fiber chains, enhancing the crystalline character. Functionally this means that lyocell maintains its strength when wet, whereas viscose loses strength when wet. They are both renewable fibers that are commercially available in nonwoven forms from numerous suppliers. Both renewable fibers lyocell and viscose can have varying diameter, shape, elastic modulus, tensile strength and failure strain that is tunable during the fiber production.

In certain embodiments, the wipe substrate is made up of at least 50%, at least 60%, at least 70%, at least 80%, at least 90%, at least 95%, or 100% of the cellulosic fibers comprising lyocell and viscose. In preferred embodiments, the wipe substrate is made up of at least 90%, at least 95%, or 100% of the cellulosic fibers comprising lyocell and viscose. In embodiments, the wipe substrate is made up of about 100% of the cellulosic fibers lyocell and viscose.

In certain embodiments, the wipe substrate is substantially free or free of thermoplastic fibers and polymers, namely petrochemically derived thermoplastic fibers and polymers including for example, polypropylene (PP), polyvinyl chloride (PVC), polyethylene (PE), polyesters, including polyethylene terephthalate (PET), polyethers, polyacrylics, polyamides, polyesteramides, polyvinylalcohols, polystyrenes, and the like. In an embodiment, the wipe substrate and wipe composition is substantially free or free of synthetic fibers.

In embodiments, the substrate wipe is a nonwoven substrate. Nonwoven substrates can be formed by any suitable technique as readily apparent to those of skill in the art, including for example where fibers are interlaid (often in a non-identifiable manner, i.e., nonwoven). Known techniques include for example, meltblown, spunbond, spunlaid, SMS (spunbond-meltblown-spunbond), co-formed, carded webs, thermal bonded, thermoformed, spunlace, hydroentangled, hydroembossed, needled, or chemically bonded. In embodiments where multiple layers of the fibers are used, they may be bonded through any suitable technique as readily apparent to those of skill in the art, including for example hydroentangling. In an embodiment the wipe compositions comprise spunlace or hydroentangled cellulose or modified cellulose fibers.

The wipe substrates described herein can also take various shapes and sizes, which are not intended to limit the scope of the disclosure herein. For example, wipes can include a single sheet of material, layers of material (e.g., 2 or more layers), material designed to conform to a particular shape, material suitable for affixing to a cleaning apparatus or implement (e.g., cleaning tool). Most commonly the substrate is in the form of a wipe.

In embodiments, the wipe is a single or multi-use substrate. In some embodiments, beneficially the wipe compositions even when provided as single-use compositions are biodegradable or compostable.

The fibers have a basis weight (referring to the individual layers of the wipe substrate) measured in grams per square meter (GSM). In some embodiments the basis weight of the wipe substrate derived from cellulosic fibers is about 1 to about 200 GSM, or from about 20 to about 60 GSM. Exemplary nonwoven substrates are described in U.S. Patent Publication 2012/066852 and U.S. Patent Publication 2011/244199.

In an embodiment, wipe composition is saturated, meaning the liquid concentrate or a RTU composition is saturated onto the wipe substrate. Wipes can be saturated with the compositions in advance of use for a length of time from a few seconds, such as about 20 seconds, 30 seconds, 45 seconds, etc. Wipes can be saturated with the compositions in advance of use for a few minutes, such as 1 minute, 2 minutes, 5 minutes, 10 minutes and up to about 7 days. Pre-saturated wipes may be sold in airtight containers. Such pre-saturated wipes may be in contact with the use solution or RTU composition for days, weeks, months, or longer periods such as at least a year.

The wipe compositions may be packaged in a variety of convenient containers or container systems. In embodiments the wipe substrates (for later contacting the use solution or RTU solution) may also be packaged the containers or container systems. In embodiments, the container or container system includes a vessel or container for storage and dispensing, such as a flowpack container including a flexible film with wipe stack contained therein. In preferred embodiments the container or container system includes a lid to reduce spillage and/or evaporation of the sanitizing or disinfecting composition. In preferred embodiments the container or container system has a lid that allows the wipes to be pulled through an opening of the container that causes minimal leakage and no tearing of the wipe substrate. Preferably the wipes are packaged in rolls, stacks or piles made up of any number of wipes. Typically, the container or container system houses from 10 to about 500 wipes. In embodiments, the wipe substrate may be perforated into individual use sizes that can be easily removed from the container or container system by a user.

### Methods of Use

The wipe compositions are particularly well suited for treating surfaces in need of sanitizing and/or antimicrobial efficacy, including for example virucidal efficacy. In further aspects, the wipe compositions are still further well suited for treating surfaces in need of antimicrobial and virucidal efficacy against small, non-enveloped viruses, large, non-enveloped viruses and/or any enveloped viruses without the use of any quaternary ammonium compounds and/or anionic surfactants having regulatory limitations. In a particular aspect, the wipe compositions are particularly well suited for providing efficacy against microbial and viral pathogens while providing surface compatible and surface polishing formulations that do not leave soil residues, hazy, streaky, and/or tacky residues on treated surfaces and do not require PPE.

Methods of inactivating a viral population, including methods of inactivating Murine Norovirus are encompassed according to the present disclosure as disclosed in U.S. Publication No. 2021/0176986, the entire contents of which are incorporated by reference in its entirety.

The methods of use for sanitizing and/or antimicrobial, including antiviral, disinfection along with inactivating viruses, include a contacting step, wherein the wipe compositions are applied to a surface in need of treatment. Such surfaces in need of treatment may be hard surfaces having soils and/or soil residues or other undesirable appearances (e.g., hazy or streaky appearances, tacky residues, or the like) following an initial sanitizing step, such as often remains on glassware, dishes and/or other wares (e.g., flatware) due to the presence of tenacious soils. However, such surfaces can also include those contaminated with soils, microbes, viruses, bacteria, and/or other hazy or streaky appearances, tacky residues, or the like.

Exemplary surfaces (e.g., glassware, dishes, and/or flatware) compatible with the wipe composition may be made of, but are not limited to, hard surface materials such as wood, vinyl, hard metals (e.g., stainless steel, aluminum, chrome, bronze, nickel, and sterling silver), melamine, acrylic, plastics, glass, stone (natural or synthetic), tile, grout, caulk, concrete, and/or leather. In embodiments, surfaces that are softer, or more susceptible and/or sensitive to certain chemistries, such as copper, brass, and marble, may not be compatible with the wipe composition when used over long periods of time.

In an aspect, contacting the wipe composition to such surfaces is intended to remove such soils and/or soil residues or other undesirable appearances (e.g., hazy or streaky appearances, tacky residues, or the like) while maintaining a food safe contact surface that does not require a rinsing step. This beneficially provides a sanitizing polishing result for the surface in need of treatment.

Certain soils, such as lipstick, hard water deposits (carbonate and the like), permanent marker, and coffee and/or tea stains are not easily removable and can leave surfaces with hazy or streaky appearances, and/or tacky residues. Beneficially, in an aspect, the contacting of the wipe composition to a surface cleans the residues and polishes or removes the hazy or streaky appearances, improving the appearance and shine of the surface, while maintaining a sanitized surface. In a further aspect, the contacting of the wipe composition to a surface contaminated with a soil is applied by hand, meaning that the surface is hand polished, or by some other mechanical force to remove the residues or hazy or streaky appearances, improving the appearance and shine of the surface.

In other aspects, contacting the wipe composition is to a surface contaminated with a virus. The contaminated surfaces can be precleaned and/or soiled. In a further aspect, the methods of use provide complete kill of a Norovirus. Beneficially, in an aspect, greater than a 99.9% reduction (3-log order reduction) in such population, greater than 99.99% reduction (4-log order reduction) in such populations, or greater than a 99.999% reduction (5-log order reduction) in the population of a Norovirus on a surface.

In a further aspect, contacting the wipe composition can be to a food contact and/or non-food contact hard surface. Surfaces can also include those cleaned in third-sink sanitizing, including various wares.

The various surfaces to which the compositions can be applied can include any conventional application means. Application can include, for example, by wiping, spraying and wiping, dipping or otherwise immersing and then wiping, or the like. In an embodiment, applications can include a wipe that is saturated with the wipe composition.

In an embodiment, the methods can include a first step of saturating, loading, impregnating, or dosing a wipe or substrate with the use solution of the wipe composition or a RTU composition. In an aspect, the use solution of the wipe composition is used to saturate the substrate for contacting a surface creating a saturated wipe. In a further aspect, the use solution of the wipe composition saturated wipe is used to contact a surface that has soils and/or soil residue, hazy, streaky, and/or tacky residues, such as ware, glassware, dishes, and flatware, that may be soiled or precleaned. The contacting of the saturated wipe to the surface can remove such hazy or streaky appearances, tacky residues, soil, pathogens, and the like, to improve the appearance and shine of the surface while maintaining sanitation.

The contacting step allows the composition to contact the surface in need of treatment for a predetermined amount of time. The amount of time can be sufficient to allow, including from a few seconds to a few minutes, or any range therebetween. The methods may comprise a single step of applying the composition onto the surface, i.e. a wiping step.

Beneficially, in various embodiments the compositions can optionally provide a no-rinse application. As a further benefit, in various embodiments the compositions can provide a wiping application. As a still further benefit, in various embodiments the compositions can provide a no-rinse and no wiping application.

In some aspects, the methods can further include a precleaning step, such as where a cleaning composition is applied, wiped and/or rinsed, and thereafter followed by the applying of the compositions. The compositions and methods of use thereof can include treating cleaned or soiled surfaces. In some embodiments the amount of contact time between the composition and the surface is sufficient to reduce the population of microorganisms (including Murine Norovirus as a surrogate for norovirus) on a surface to provide greater than a 99.9% reduction (3-log order reduction) in such population, greater than 99.99% reduction (4-log order reduction) in such populations, or greater than a 99.999% reduction (5-log order reduction) in the population of microorganisms and pathogens. The contact time is preferably less than about 30 minutes, less than about 15 minutes, less than about 5 minutes, or even less than 1 minute.

Temperature conditions for the methods can range from about 40° F.-160° F., about 60° F.-140° F., or about 70° F.-140° F. In general, the temperature conditions are not meant to limit application of use of the compositions as described in the methods herein.

Beneficially, the methods do not require a rinse step. In an aspect, the compositions are food contact approved and do not require a rinse step. As a further benefit, the methods do not cause corrosion and/or interfere with surfaces (e.g., hazy, dull or other negative aesthetic effects on the surface).

In embodiments, the wipe compositions meet bactericidal requirements for EN1276 (bacterial suspension study), EN13697 (bacteria-carrier based study), and EN16615 (bacteria-carrier based study) at 18° C.-25° C. under clean and/or dirty conditions. In embodiments, the wipe compositions meet virucidal requirements for EN14476 at 18° C.-25° C. under clean and/or dirty conditions. As one skilled in the art will appreciate, the suspension studies can also be referred to as Phase 2, Step 1 (or 2.1-suspension) studies and the carrier studies can also be referred to as Phase 2, Step 2 (or 2.2-carrier) studies or also laboratory simulated surface tests.

### Kits

The wipe compositions can be provided in a kit form as well. A kit can comprise the composition, a container for housing wipe substrates and/or the wipe composition, and optionally instructions for use thereof. The container may be any suitable vessel for containing/housing for containing the wipe substrates and/or wipe composition. The container may contain the solid concentrate composition, the liquid concentrate composition, or the ready-to-use (RTU) composition. In embodiments, the kit comprises a solid concentrate composition in a tablet, pellet, or block form. In embodiments, the kit can further comprise water for dilution of the solid concentrate composition. In embodiments, the instructions for use can comprise instructions for dilution and/or use of the saturated wipes.

All publications and patent applications in this specification are indicative of the level of ordinary skill in the art to which this invention pertains. All publications and patent applications are herein incorporated by reference to the same extent as if each individual publication or patent application were specifically and individually indicated as incorporated by reference.

### PREFERRED EMBODIMENTS

1. A method of using a wipe composition comprising: contacting a wipe composition to a surface in need of treatment with a wipe substrate, wherein the wipe composition comprises at least one acid, wherein the acid comprises a strong acid, a weak acid, or combinations thereof and at least one anionic surfactant, wherein the composition has a pH of less than or equal to about 5, and wherein the method removes soils, hazy, streaky, and/or tacky residues from the surface without requiring a rinse step.

2. The method of embodiment 1, wherein the wipe composition is a pre-saturated wipe.

3. The method of any one of embodiments 1-2, wherein the surface is a hard surface, and wherein the hard surface is a precleaned hard surface.

4. The method of any one of embodiments 1-3, wherein the soil is at least one of hard water spots, food soil, and cosmetic soils.

5. The method of any one of embodiments 1-3, wherein the hard surface is glassware, dishes and/or flatware, and wherein the glassware, dishes and/or flatware are hard metal, melamine, acrylic and/or plastic, and optionally wherein the hard metal is stainless steel, aluminum, chrome, bronze, nickel, and/or sterling silver.

6. The method of any one of embodiments 1-5, wherein the contacting further provides complete kill of a virus and/or achieves at least a 3-log microbial reduction from the surface.

7. The method of any one of embodiments 1-6, wherein the wipe composition is diluted from a liquid concentrate composition at a rate of from about ⅛ oz./gal. to about 12 oz./gal. to form a use solution of the wipe composition, or wherein the wipe composition is formed from a liquid or solid concentrate composition.

8. The method of any one of embodiments 1-7, wherein the at least one acid is citric acid or lactic acid.

9. The method of any one of embodiments 1-8, wherein the at least one anionic surfactant is a sulfonate, sulfate, and/or carboxylate anionic surfactant.

10. The method of any one of embodiments 1-9, wherein the sulfonate anionic surfactant is an alkyl sulfonate or an aromatic sulfonate.

11. The method of embodiment 10, wherein the alkyl sulfonate is a linear and branched primary or secondary alkyl sulfonate, and the aromatic sulfonate is with or without substituent(s), or preferably wherein the alkyl sulfonate is a linear alkyl benzene sulfonic acid or an alpha olefin sulfonate.

12. The method of any one of embodiments 1-9, wherein the sulfate anionic surfactant is an alkyl ether sulfate, an alkyl sulfate, an alkyl ethoxysulfate, a fatty oleyl glycerol sulfate, or an alkyl phenol ethylene oxide ether sulfate.

13. The method of any one of embodiments 1-9, wherein the carboxylate anionic surfactant is a carboxylic acid, an ester carboxylic acid, an ether carboxylic acid, alkyl ether carboxylate, alcohol ether carboxylate, or a sulfonated fatty acid.

14. The method of any one of embodiments 1-13, the wipe composition further comprises from about 1 wt-% to about 20 wt-% of an additional surfactant.

15. The method of any one of embodiments 1-14, the wipe composition further comprises from about 1 wt-% to about 20 wt-% of fatty acid ester.

16. The method of any one of embodiments 1-15, wherein the composition has a use pH from about 2 to about 5, about 2 to about 4, or about 2 to about 3.

17. The method of any one of embodiments 1-16, wherein the at least one acid comprises from about 1 wt-% to about 80 wt-% and wherein the at least one anionic surfactant comprises from about 0.1 wt-% to about 50 wt-% in a concentrate wipe composition.

18. The method of any one of embodiments 1-16, wherein the at least one acid comprises from about 0.025 wt-% to about 38 wt-% and wherein the at least one anionic surfactant comprises from about 0.025 wt-% to about 38 wt-% in a use solution or RTU wipe composition.

19. The method of any one of embodiments 1-18, wherein the method further comprises an initial step of diluting a concentrate wipe composition to form a use solution and saturating the use solution onto the wipe substrate.

20. The method of any one of embodiments 1-19, wherein the wipe substrate comprises cellulosic and/or modified cellulose fibers.

21. A wipe composition kit comprising: a canister or container housing wipe substrates; and a solid concentrate composition comprising at least one acid, wherein the acid comprises a strong acid, a weak acid, or combinations thereof, at least one anionic surfactant, and a solidifying agent, wherein the concentrate composition when diluted has a pH of less than or equal to about 5.

22. The kit of embodiment 21, wherein the solid concentrate composition is a tablet, pellet or block.

23. The kit of any one of embodiments 21-22, further comprising water for dilution.

24. The kit of any one of embodiments 21-23, further comprising instructions for dilution and/or use.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following abbreviations and/or tradenames for products used in the Examples are described in further detail below:
Bioterge AS-40: an alpha olefin sulfonate (AOS) commercially available from Stepan.
Texapon LS30: sodium lauryl sulfate (SLS) commercially available from BASF.
Sulfopon 101UP: sodium lauryl sulfate (SLS) commercially available from BASF.
Calfoam SLS 30: sodium lauryl sulfate (SLS) commercially available from Pilot Chemical.
Biosoft S-101: linear alkyl benzene sulfonic acid (LAS) commercially available from Stepan.
Calsoft LAS-99: linear alkyl benzene sulfonic acid (LAS) commercially available from Pilot Chemical.
Commercially available from various sources: lactic acid (88%) and citric acid (50%).

### Example 1

Efficacy of cleaning and polishing of an exemplary polishing wipe composition was compared to water on tea-stained ceramic tiles. A tea bath was made by combining 150 bags of black tea and 6 liters of 160° F. 17 gpg water for 5 minutes. Ceramic tiles were fully cleaned and dipped into the tea bath 25 times. After drying, the tea-stained ceramic tiles were wiped by hand with water and the exemplary polishing wipe composition shown in Table 4 diluted to 0.3 oz/gal in 5 gpg with wypall cloth. The tiles were wiped 3-5 times.

TABLE 4

| Component | Wt-% |
|---|---|
| Weak acid | 30-40 |
| Strong acid | 10-15 |
| Anionic Surfactant (a linear alkyl benzene | 10-20 |
| sulfonic acid) | |
| Additional Functional Ingredients (Nonionic | 1-10 |
| surfactant, dye) | |
| Water | 25-50 |

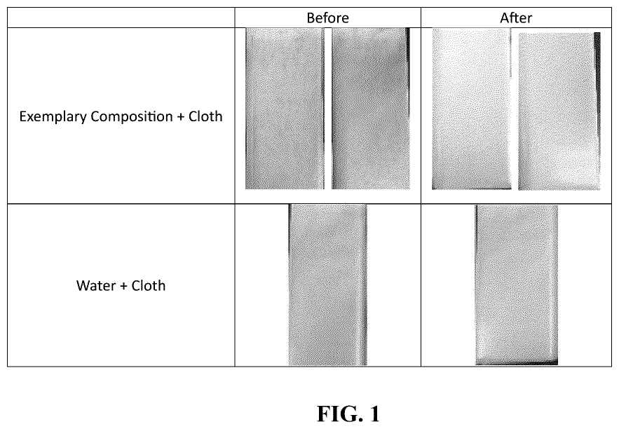

Results are shown in FIG. 1. The results show that the exemplary polishing wipe composition provides superior cleaning than wiping with water.

### Example 2

Efficacy of cleaning and polishing of the exemplary polishing wipe composition of Table 4 was additionally compared to water on soiled flatware. The soiled flatware were obtained from a field account and washed without the soil fully removed in the washing step resulting in the need for a further manual hand polishing step with the exemplary polishing wipe composition. The flatware were then wiped by hand with water and the exemplary polishing wipe composition diluted to 0.3 oz/gal with 5 gpg water and applied with wypall cloth. The flatware were wiped 3-5 times.

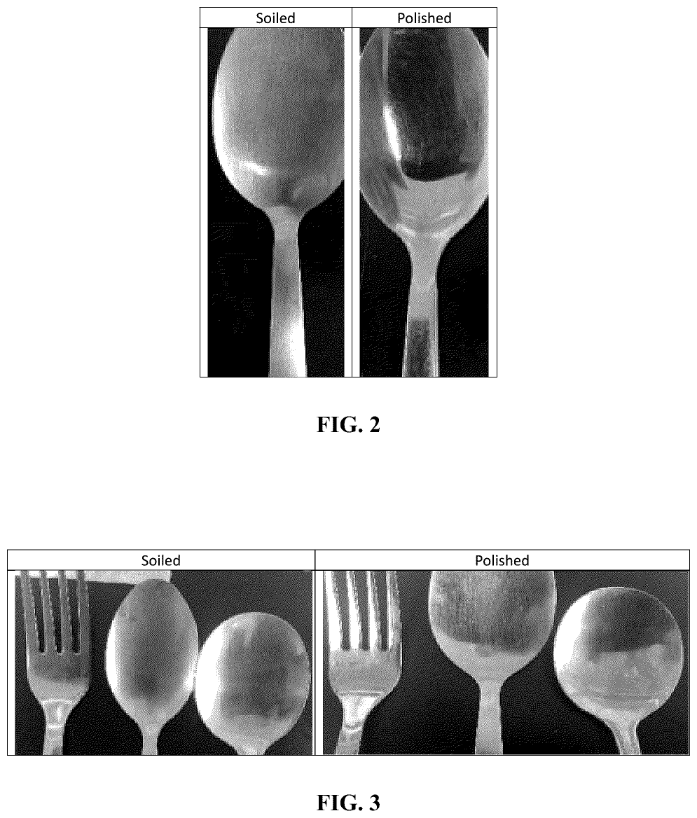

Results are shown in FIGS. 2 and 3. The results show that the exemplary polishing wipe composition provides superior cleaning than wiping with water.

### Example 3

Efficacy of cleaning and polishing of the exemplary polishing wipe composition was additionally compared to water on protein soiled ceramic tile. A 50:50 cream of chicken soup to whole milk soil was applied to the ceramic tiles which were then baked at 71° C. for 4 minutes. Then at 160° F. they were washed with 2000 ppm beef stew soils. This cycle of soiling was repeated 5 times. The tiles were fan dried for 1 hour and then washed in 5 gpg water for 5 cycles before drying overnight. The tiles were then ready for use in a 10 cycle reclaim method to assess removal of stubborn soils and residues. A warewash machine was run with detergent (with no food soils) with all tiles, removing 1 ceramic tile after each wash.

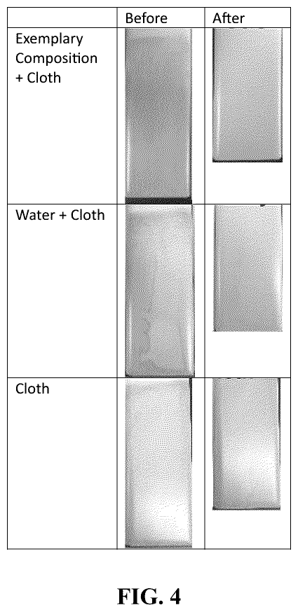

The exemplary polishing wipe composition of Table 4 was diluted to 0.3 oz/gal in 5 gpg water and applied to the soiled tile with a wypall cloth. The water was also applied with a wypall cloth. Additionally, a dry wypall cloth was used on the soiled tile. Results in FIG. 4 show that the exemplary composition is more effective in removing the soils than water or dry wypall cloth.

### Example 4

Efficacy of cleaning and polishing of the exemplary polishing wipe composition was additionally compared to water on glass beakers with red lipstick and permanent marker soils. A glass beaker was soiled with a stripe of red lipstick and black permanent marker. The exemplary polishing wipe composition was diluted to 0.3 oz/gal in 5 gpg water and applied to the soiled glass beaker with a wypall cloth. The water was also applied with a wypall cloth. The soils were wiped until fully removed and the number of wipes required for removal was record.

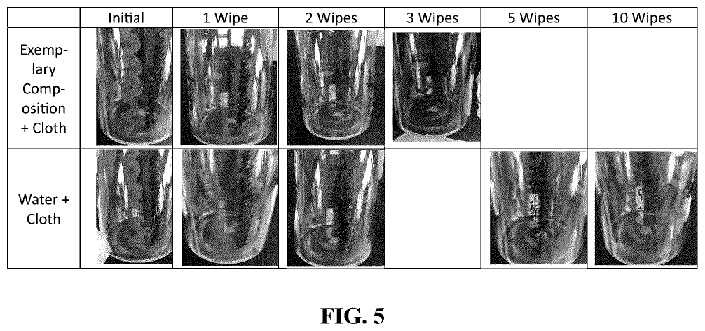

FIG. 5 shows that after 3 wipes, the exemplary composition is more effective at removing both lipstick and permanent marker after 3 wipes than water after 10 wipes.

### Example 5

Various materials were evaluated for compatibility with the exemplary polishing wipe composition. The exemplary polishing wipe composition of Table 4 was diluted to 0.55 oz/gal with 5 gpg water and was applied to material samples 400 times. The exemplary composition was allowed to dwell for 5 minutes between applications. The material samples were visually inspected for any changes to the material sample appearance. Table 5 below, describes the material samples and any visual observations before and after application of the exemplary polishing wipe composition.

TABLE 5

| | Observations | |
|---|---|---|
| | | After 400 |
| Sample | Initial | Applications |
| Painted Wood | New/No Observable Damage | Passed |
| Varathane/Acrylic | New/No Observable Damage | Passed |
| Sealed Wood | | |
| Sellac/Minwax ® | New/No Observable Damage | Sealant damaged |
| Sealed Wood | | |
| Vinyl | New/No Observable Damage | Passed |
| Laminated Menu | New/No Observable Damage | Passed |
| 316 Stainless Steel | New/No Observable Damage | Passed |
| 304 Stainless Steel | New/No Observable Damage | Passed |
| Aluminum 6061 | New/No Observable Damage | Passed |
| Aluminum 7075 | New/No Observable Damage | Passed |
| Brass (360) | New/No Observable Damage | Significant |
| | | discoloration |
| Polished Chrome | New/No Observable Damage | Passed |
| Copper | New/No Observable Damage | Significant |
| | | discoloration; |
| | | loss of gloss |
| Oil-Rubbed | New/No Observable Damage | Passed |
| Bronze | | |
| Polished Nickel | New/No Observable Damage | Passed |
| Brushed Bronze | New/No Observable Damage | Passed |
| Brushed Nickel | New/No Observable Damage | Passed |
| Melamine | New/No Observable Damage | Passed |
| Acrylic | New/No Observable Damage | Passed |
| (Plexiglass) | | |
| Fiberglass- | New/No Observable Damage | Passed |
| Reinforced Plastic | | |
| Natural Marble | New/No Observable Damage | Loss of gloss |
| Synthetic | New/No Observable Damage | Passed |
| (“Cultured”) | | |
| Marble, polished | | |
| Travertine | New/No Observable Damage | Passed |
| Granite | New/No Observable Damage | Passed |
| Field Basalt | New/No Observable Damage | Passed |
| Porcelain Tile | New/No Observable Damage | Passed |
| Ceramic Tile | New/No Observable Damage | Passed |
| Quartz | New/No Observable Damage | Passed |
| Quarry Tile | New/No Observable Damage | Passed |
| Spectralock ® | New/No Observable Damage | Passed |
| Grout | | |
| Standard Grout | New/No Observable Damage | Passed |
| Acrylic Caulk | New/No Observable Damage | Passed |
| Silicone Caulk | New/No Observable Damage | Passed |
| Sterling Silver | Used | Passed |
| Ware | | |
| Polished Concrete | New/No Observable Damage | Passed |
| Leather | New/No Observable Damage | Passed |

As can be shown in Table 5, the exemplary composition was compatible with many of the surface materials except the shellac/Minax® sealed wood, brass, copper, and natural marble. The shellac/Minax® sealed wood resulted in the sealant being damaged. The brass and copper both resulted in darkening of the surface as well as a loss of gloss. The natural marble resulted only in the loss of gloss. It is theorized that since softer materials, such as soft metals (e.g., copper and brass) and marble, are generally sensitive to many chemistries and thus require specialized cleaning compositions, the exemplary polishing wipe composition may not be compatible with these materials when used for a long period of time. Yet, hard surface materials such as stainless steel, aluminum, chrome, bronze, nickel sterling silver, melamine, and acrylic passed the testing showing compatibility with the polishing wipe composition after long periods of time (400 applications).

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. A method of using a wipe composition comprising:
contacting a wipe composition to a surface in need of treatment with a wipe substrate,
wherein the wipe composition comprises at least one acid, wherein the acid comprises a strong acid, a weak acid, or combinations thereof and at least one anionic surfactant,
wherein the composition has a pH of less than or equal to about 5, and
wherein the method removes soils, hazy, streaky, and/or tacky residues from the surface without requiring a rinse step.

2. The method of claim 1, wherein the wipe composition is a pre-saturated wipe.

3. The method of claim 1, wherein the surface is a hard surface, and wherein the hard surface is a precleaned hard surface.

4. The method of claim 1, wherein the soil is at least one of hard water spots, food soil, and cosmetic soils.

5. The method of claim 3, wherein the hard surface is glassware, dishes and/or flatware, and/or wherein the hard surface is a hard metal, glass, melamine, acrylic, and/or plastic.

6. The method of claim 1, wherein the contacting further provides complete kill of a virus and/or achieves at least a 3-log microbial reduction from the surface.

7. The method of claim 1, wherein the wipe composition is diluted from a liquid concentrate composition at a rate of from about ⅛ oz./gal. to about 12 oz./gal. to form a use solution of the wipe composition, or wherein the wipe composition is formed from a liquid or solid concentrate composition.

8. The method of claim 1, wherein the at least one acid is citric acid or lactic acid.

9. The method of claim 1, wherein the at least one anionic surfactant is a sulfonate, sulfate, and/or carboxylate anionic surfactant.

10. The method of claim 1, wherein the sulfonate anionic surfactant is an alkyl sulfonate or an aromatic sulfonate, wherein the alkyl sulfonate is a linear and branched primary or secondary alkyl sulfonate, and the aromatic sulfonate is with or without substituent(s), or preferably wherein the alkyl sulfonate is a linear alkyl benzene sulfonic acid or an alpha olefin sulfonate.

11. The method of claim 1, wherein the sulfate anionic surfactant is an alkyl ether sulfate, an alkyl sulfate, an alkyl ethoxysulfate, a fatty oleyl glycerol sulfate, or an alkyl phenol ethylene oxide ether sulfate.

12. The method of claim 1, wherein the carboxylate anionic surfactant is a carboxylic acid, an ester carboxylic acid, an ether carboxylic acid, alkyl ether carboxylate, alcohol ether carboxylate, or a sulfonated fatty acid.

13. The method of claim 1, wherein the wipe composition further comprises from about 1 wt-% to about 20 wt-% of an additional surfactant, and/or further comprises from about 1 wt-% to about 20 wt-% of fatty acid ester.

14. The method of claim 1, wherein the composition has a use pH from about 2 to about 5.

15. The method of claim 1, wherein the at least one acid comprises from about 1 wt-% to about 80 wt-% and wherein the at least one anionic surfactant comprises from about 0.1 wt-% to about 50 wt-% in a concentrate wipe composition, or wherein the at least one acid comprises from about 0.025 wt-% to about 38 wt-% and wherein the at least one anionic surfactant comprises from about 0.025 wt-% to about 38 wt-% in a use solution or RTU wipe composition.

16. The method of claim 1, wherein the method further comprises an initial step of diluting a concentrate wipe composition to form a use solution and saturating the use solution onto the wipe substrate.

17. The method of claim 1, wherein the wipe substrate comprises cellulosic and/or modified cellulose fibers.

18. A wipe composition kit comprising:
a canister or container housing wipe substrates; and
a solid concentrate composition comprising at least one acid, wherein the acid comprises a strong acid, a weak acid, or combinations thereof, at least one anionic surfactant, and a solidifying agent, wherein the concentrate composition when diluted has a pH of less than or equal to about 5.

19. The kit of claim 18, wherein the solid concentrate composition is a tablet, pellet or block.

20. The kit of claim 18, further comprising water for dilution and/or further comprising instructions for dilution and/or use.
